(19) United States
(12) Patent Application Publication
(10) Pub. No.: US 2023/0199123 A1
(43) Pub. Date: Jun. 22, 2023

(54) IMAGE FORMING DEVICE, DESTINATION SETTING METHOD, AND NON-TRANSITORY RECORDING MEDIUM

(71) Applicant: Toshiba Tec Kabushiki Kaisha, Tokyo (JP)

(72) Inventor: Toshihiro IDA, Mishima (JP)

(73) Assignee: Toshiba Tec Kabushiki Kaisha, Tokyo (JP)

(21) Appl. No.: 17/556,447

(22) Filed: Dec. 20, 2021

(51) Int. Cl. H04N 1/00; H04N 1/44; G06F 21/35

(52) U.S. Cl. CPC H04N 1/00214; H04N 1/4413; H04N 1/00411; H04N 1/00212; G06F 21/35

(57) ABSTRACT

An image forming device is an image forming device in a destination setting system, and the destination setting system includes the image forming device and a wireless communication device used by a user who uses the image forming device. The image forming device has a communication unit and a control unit. The communication unit receives destination information transmitted from the wireless communication device among one or more destination information stored in the wireless communication device. The control unit sets the destination information received by the communication unit as a destination in a transmission function of image data.

### FIELD

Embodiments described herein relate generally to an image forming device, a destination setting method, and a non-transitory recording medium.

### BACKGROUND

When scanning transmission or fax transmission is used in an image forming device, a user selects a destination in an address book linked with the image forming device in advance. As a result, it is possible to easily set the destination of the scanning transmission or the fax transmission in the image forming device. However, when the scanning transmission or the fax transmission is performed to a destination that is not registered in the address book, it is necessary to manually input the destination.

### DESCRIPTION OF THE DRAWINGS

FIG. 1 is a diagram showing a configuration of a destination setting system according to a first embodiment;

FIG. 2 is a block diagram showing a hardware configuration of an information processing device;

FIG. 3 is a diagram showing an example of an address information table;

FIG. 4 is a block diagram showing a hardware configuration of an image forming device;

FIG. 5 is a flowchart showing a flow of a destination information selection process in a wireless communication device;

FIG. 6 is a flowchart showing a flow of an authentication process in the wireless communication device;

FIG. 7 is a flowchart showing a flow of a display process of the wireless communication device;

FIG. 8 is a diagram showing an example of a screen displayed on a display of the image forming device;

FIG. 9 is a flowchart showing a flow of a destination setting process performed by the image forming device;

FIG. 10 is a block diagram showing a hardware configuration of an image forming device according to a second embodiment;

and

FIG. 11 is a sequence diagram showing a flow of a process of a destination setting system.

### DETAILED DESCRIPTION

In general, according to at least one embodiment, an image forming device in a destination setting system is provided, and the destination setting system includes the image forming device and a wireless communication device used by a user who uses the image forming device. The image forming device has a communication unit (interface) and a control unit (controller). The communication unit receives destination information transmitted from the wireless communication device among one or more destination information stored in the wireless communication device. The control unit sets the destination information received by the communication unit as a destination in a transmission function of image data.

Hereinafter, an image forming device, a destination setting method, and a non-transitory recording medium of embodiments will be described with reference to drawings.

### First Embodiment

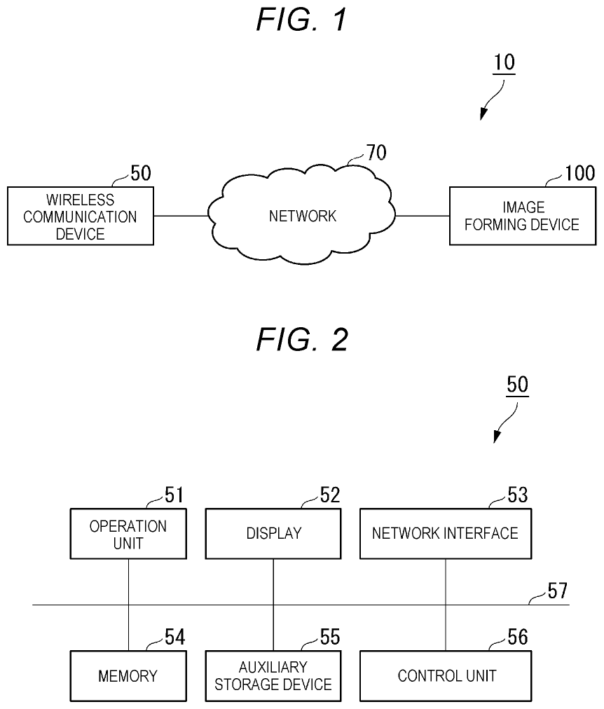

FIG. 1 is a diagram showing a configuration of a destination setting system 10 according to a first embodiment.

The destination setting system 10 includes a wireless communication device 50 and an image forming device 100. The wireless communication device 50 and the image forming device 100 are communicably connected to each other via a network 70. The network 70 may be a network configured in any manner. For example, the network 70 is a network such as short-range wireless communication or a wireless local area network (LAN).

The destination setting system 10 transmits destination information registered in an address book of the wireless communication device 50 to the image forming device 100, and sets the destination information as a destination of a transmission function executed by the image forming device 100. The destination information registered in the address book of the wireless communication device 50 is, for example, information such as a telephone number and an e-mail address. The transmission function executed by the image forming device 100 is, for example, scanning transmission, fax transmission, and the like. As described above, the destination setting system 10 sets the destination information registered in the address book of the wireless communication device 50 as a destination when the image forming device 100 performs the scanning transmission or the fax transmission.

The wireless communication device 50 is operated by, for example, a user who uses the transmission function of the image forming device 100. The wireless communication device 50 determines the destination information to be transmitted to the image forming device 100 in accordance with the operation of the user. The wireless communication device 50 transmits the determined destination information to the image forming device 100.

When the destination information is selected by the user, the wireless communication device 50 generates authentication information used for authentication when the destination information is transmitted. The authentication information is, for example, a one-time password. The wireless communication device 50 performs the authentication using the authentication information transmitted from the image forming device 100 and the generated authentication information. When the authentication is made by the authentication information, the wireless communication device 50 transmits the destination information selected by the user to the image forming device 100. The wireless communication device 50 is configured by using an information processing device such as a personal computer, a notebook computer, a tablet terminal, and a smartphone.

The image forming device 100 is a multi function peripheral (MFP) capable of forming a toner image on a sheet. The sheet is, for example, a paper on which characters, images, and the like are formed. The sheet may be any material as long as the image forming device 100 can form an image thereon. The image forming device 100 reads the image appearing on the sheet, generates digital data, and generates image information.

The image forming device 100 executes printing by an image forming process and an image fixing process. The image forming process is a process of forming an image on a sheet. The image fixing process is a process of fixing the image formed on the sheet on the sheet. Further, the image forming device 100 has the transmission function. The image forming device 100 sets a destination indicated by the destination information transmitted from the wireless communication device 50 as the destination of the transmission function in accordance with the operation of the user.

FIG. 2 is a block diagram showing a hardware configuration of the wireless communication device 50 according to the first embodiment.

The wireless communication device 50 includes an operation unit 51, a display 52, a network interface 53, a memory 54, an auxiliary storage device 55, and a control unit 56. Functional units are connected to each other so as to mutually perform data communication via a system bus 57.

The operation unit 51 accepts the operation of the user. The operation unit 51 outputs a signal corresponding to the operation performed by the user to the control unit 56. The operation unit 51 and the display 52 may be configured as an integrated touch panel.

The display 52 is an image display device such as a liquid crystal display or an organic electro luminescence (EL) display. The display 52 displays various information on the wireless communication device 50. In addition, the display 52 outputs the signal corresponding to the operation performed by the user to the control unit 56.

The network interface 53 transmits and receives data to and from another device. Here, the other device is, for example, the image forming device 100. The network interface 53 operates as an input interface and receives the data or an instruction transmitted from the other device. The network interface 53 operates as an output interface and transmits the destination information to the other device.

The memory 54 temporarily stores data used by the functional units included in the wireless communication device 50. The memory 54 is, for example, a random access memory (RAM).

The auxiliary storage device 55 is, for example, a hard disk or a solid state drive (SSD) and stores various data. The various data are, for example, an application program, an address information table, and the like. The application program is a program executed by the control unit 56 (for example, a program for realizing the destination setting system 10). When the application program is executed by the control unit 56, the wireless communication device 50 can generate the authentication information and exchange the destination information with the wireless communication device 50.

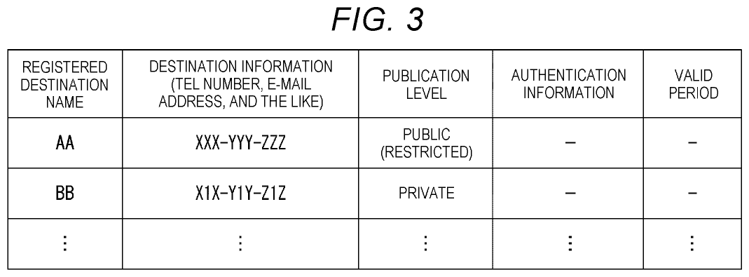

The address information table is a table in which information on an address of the user registered in the wireless communication device 50 is registered. FIG. 3 is a diagram showing an example of the address information table according to the first embodiment. The address information table includes a plurality of records in which values of a registered destination name, destination information, a publication level, authentication information, and a valid period are associated with each other. The registered destination name represents a registered name of the user registered in the wireless communication device 50. The destination information represents information such as a telephone number and an e-mail address of a user identified by the registered destination name.

The publication level indicates a degree of publication possibility of the destination information to another device. For example, as the publication level, at least either “public” indicating that the destination information may be public or “private” indicating that the destination information is not public can be set. The publication may include a restricted publication and an unrestricted publication. The restricted publication indicates that the destination information can be public to the other device, but the destination information cannot be registered in the other device. The unrestricted publication indicates that the destination information can be public to the other device and the destination information can be registered in the other device. The publication level can be set by the user of the wireless communication device 50 for each user registered in the address information table.

The authentication information represents the one-time password used to determine whether the destination information of the user identified by the registered destination name is provided. If the authentication information is not generated or the valid period is passed, a value of “-” is registered in an item of authentication information. The valid period represents a period when the authentication information is considered as valid.

In FIG. 3, in a record registered in a top row of the address information table, a value of the registered destination name is “AA”, a value of the destination information is “XXX-YYY-ZZZ”, a value of the publication level is “public (restricted)”, a value of the authentication information is “-”, and a value of the valid period is “-”. That is, the destination information of the user of “AA” is “XXX-YYY-ZZZ”, which indicates that, as a publication level, the destination information can be public but cannot be registered.

In FIG. 3, in a record registered in a second row of the address information table, a value of the registered destination name is “BB”, a value of the destination information is “X1X-Y1Y-Z1Z”, a value of the publication level is “private”, a value of the authentication information is “-”, and a value of the valid period is “-”. That is, the destination information of the user of “BB” is “X1X-Y1Y-Z1Z”, which indicates that the destination information cannot be public as a publication level.

The control unit 56 is a processor such as a central processing unit (CPU) or a graphics processing unit (GPU). The control unit 56 controls operations of the functional units of the wireless communication device 50. The control unit 56 executes various processes by loading a program stored in a read only memory (ROM) or an application program stored in the auxiliary storage device 55 into a RAM and executing the program. An application specific integrated circuit (ASIC) may have an appropriate function realized by the control unit 56. The ASIC is a dedicated circuit for realizing a specific function.

Here, an example of the process of the control unit 56 will be described. The control unit 56 generates the authentication information. The control unit 56 performs the authentication based on the authentication information by comparing the generated authentication information with the authentication information transmitted from the image forming device 100. Specifically, when the generated authentication information matches the authentication information transmitted from the image forming device 100, the control unit 56 determines that the authentication is performed. On the other hand, when the generated authentication information does not match the authentication information transmitted from the image forming device 100, the control unit 56 determines that the authentication is not performed. The control unit 56 registers the publication level for each piece of destination information in accordance with the operation performed by the user.

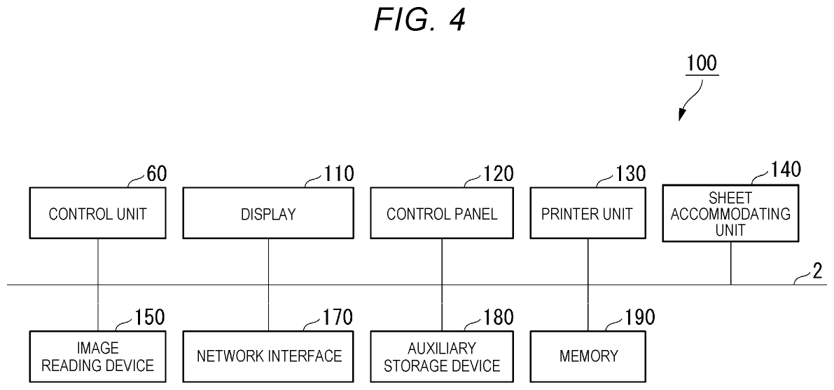

FIG. 4 is a block diagram showing a hardware configuration of the image forming device 100 according to the first embodiment.

The image forming device 100 includes a control unit 60, a display 110, a control panel 120, a printer unit 130, a sheet accommodating unit 140, an image reading device 150, a network interface 170, an auxiliary storage device 180, and a memory 190. Functional units are connected each other so as to mutually perform data communication via a system bus 2.

The display 110 may be an image display device such as a liquid crystal display or an organic EL display. The display 110 displays various information on the image forming device 100. The display 110 outputs a signal corresponding to the operation performed by the user to the control unit of the image forming device 100. The display 110 is an aspect of a display unit.

The control panel 120 includes an operation unit (operation interface). The operation unit includes a plurality of buttons and the like. The operation unit accepts an operation performed by a user. For example, the operation unit accepts an execution instruction of a transmission function and an input of authentication information. The operation unit outputs a signal corresponding to an operation performed by a user to an internal control unit. The display 110 and the control panel 120 may be configured as an integrated touch panel.

The printer unit 130 executes an image forming process and an image fixing process. Specifically, the printer unit 130 forms an image based on image information generated by the image reading device 150 or image information received via a communication path on a sheet. The printer unit 130 heats and pressurizes the sheet to fix the image (for example, a toner image) formed on the sheet on the sheet.

A sheet accommodating unit 140 may include a single or a plurality of paper feed cassettes. Each of the paper feed cassettes stores a predetermined size and a predetermined type of sheet. The predetermined type of sheet is a sheet having a different thickness. For example, the predetermined type of sheet includes a normal paper, a thick paper, and the like.

The image reading device 150 reads image information to be read as brightness and darkness of a light. For example, the image reading device 150 reads image information printed on a sheet to be read set in the image reading device 150. For example, the image reading device 150 reads image information on a front surface and image information on a back surface that are printed on a sheet. The image reading device 150 records the read image information on the front surface and the read image information on the back surface. The recorded image information may be transmitted to another information processing device via a network. The recorded image information may be image-formed on the sheet by the printer unit 130. The image reading device 150 is, for example, an auto document feeder (ADF).

The control unit 60 (controller) is a processor such as a CPU or GPU. The control unit 60 controls operations of the functional units of the image forming device 100. The control unit 60 executes various processes by loading a program stored in a ROM or the auxiliary storage device 180 into a RAM and executing the program. The ASIC may have an appropriate function realized by the control unit 60. The ASIC is the dedicated circuit for realizing the specific function.

Here, an example of the process of the control unit 60 will be described. The control unit 60 sets destination information received by the network interface 170 as a destination in a transmission function of image data. The control unit 60 displays a mobile name of one or more wireless communication devices 50 capable of communicating on the display 110 when the one or more wireless communication devices 50 capable of communicating are provided around the image forming device 100.

The control unit 60 records the destination information in the auxiliary storage device 180 when publication level information added to the destination information indicates public (unrestricted). In addition, the public (unrestricted) indicates that the destination information can be registered. The control unit 60 may display screen data for selecting whether the destination information is recorded on the display 110, and record the destination information when an instruction for recording the destination information is input.

The network interface 170 transmits and receives data to and from another device. The network interface 170 operates as an input interface and receives the data transmitted from the other device. For example, the network interface 170 receives the destination information transmitted from the wireless communication device 50 among the one or more destination information stored in the wireless communication device 50. The network interface 170 receives the destination information transmitted from the wireless communication device 50 when the wireless communication device 50 is authenticated by the authentication information.

The network interface 170 operates as an output interface and transmits data to another device. For example, the network interface 170 transmits the input authentication information to the wireless communication device 50 via the control panel 120. Here, the wireless communication device 50 to which the authentication information is transmitted by the network interface 170 is the wireless communication device 50 selected by the user. The network interface 170 is an aspect of a communication unit.

The auxiliary storage device 180 is, for example, a hard disk or a solid state drive (SSD) and stores various data. The various data are, for example, digital data, jobs, job logs, and the like. The digital data is digital data of the image information generated by the image reading device 150.

The memory 190 is, for example, a RAM. The memory 190 temporarily stores data used by the functional units included in the image forming device 100. The memory 190 may store the digital data generated by the image reading device 150. The memory 190 may temporarily store the destination information, the jobs, and the job logs.

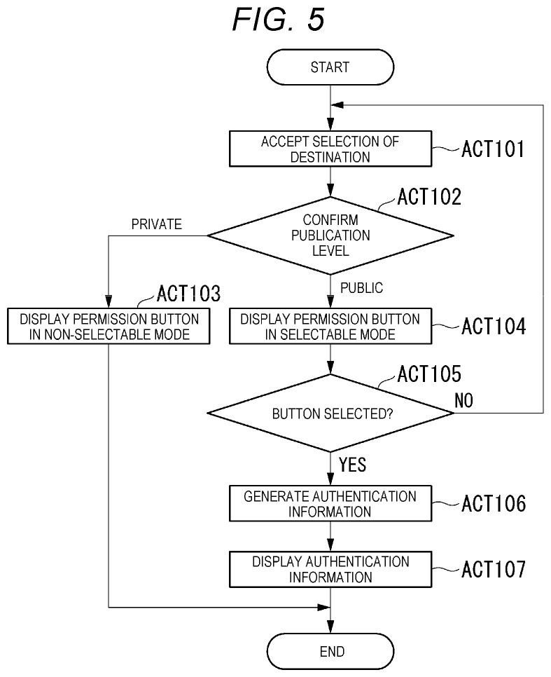

FIG. 5 is a flowchart showing a flow of a destination information selection process in the wireless communication device 50 of the first embodiment.

The control unit 56 of the wireless communication device 50 displays a destination selection screen on the display 52 and accepts a selection of the destination information according to the operation performed by the user (ACT 101). The destination selection screen is a screen for selecting the destination information to be transmitted. Information on the registered destination name registered in the address information table is displayed on the destination selection screen. The user selects a registered destination name as a destination when using the transmission function of the image forming device 100 from information of a plurality of registered destination names displayed on the display 52. When one registered destination name is selected by the user, the control unit 56 switches a screen of the wireless communication device 50 from the destination selection screen to a transmission permission screen.

The transmission permission screen is a screen for selecting whether to permit transmission of destination information. At least a permission button and a return button are displayed on the transmission permission screen. When the permission button is selected (pressed), the control unit 56 issues the authentication information. When the return button is selected (pressed), the control unit 56 switches the screen of the wireless communication device 50 from the transmission permission screen to the destination selection screen.

When the control unit 56 switches the screen of the wireless communication device 50 from the destination selection screen to the transmission permission screen, the control unit 56 confirms the publication level associated with the selected registered destination name with reference to the address information table (ACT 102). When the publication level associated with the selected registered destination name is private (ACT 102: private), the control unit 56 displays the permission button on the transmission permission screen in a non-selectable manner (ACT 103). Here, as the non-selectable manner, the permission button may be displayed in a gray scale, for example, or the permission button may not be displayed.

When the publication level is private, it means that the destination information of the user identified by the associated registered destination name cannot be public. Therefore, by displaying the permission button in the non-selectable manner, it is possible to control that the destination information whose publication level is private is not caused to be public by the user. After that, the wireless communication device 50 ends the process of FIG. 5.

On the other hand, when the publication level associated with the selected registered destination name is public (ACT 102: public), the control unit 56 displays the permission button on the transmission permission screen in a selectable manner (ACT 104). After that, the control unit 56 determines whether the permission button is selected by the user (ACT 105). When the permission button is not selected (ACT 105: NO), the process returns to ACT 101. Here, the case where the permission button is not selected is, for example, a case where the return button is selected by the user.

When the permission button is selected (ACT 105: YES), the control unit 56 generates the authentication information (ACT 106). The control unit 56 registers the generated authentication information in the item of authentication information associated with the selected registered destination name in the address information table. The control unit 56 also registers the information on the valid period of the authentication information. The length of the valid period shall be preset. The control unit 56 sets a time obtained by adding the preset length (for example, 30 seconds) to a time at which the authentication information is generated as the valid period. After that, the control unit 56 displays the generated authentication information on the screen of the wireless communication device 50 (ACT 107).

When the wireless communication device 50 that generates the authentication information receives a broadcast signal from the image forming device 100 during a period in which the authentication information is valid, the wireless communication device 50 responds by giving the mobile name of the wireless communication device 50 and the identification information (for example, a MAC address). As a result, the image forming device 100 can detect the wireless communication device 50 to be authenticated by the authentication information.

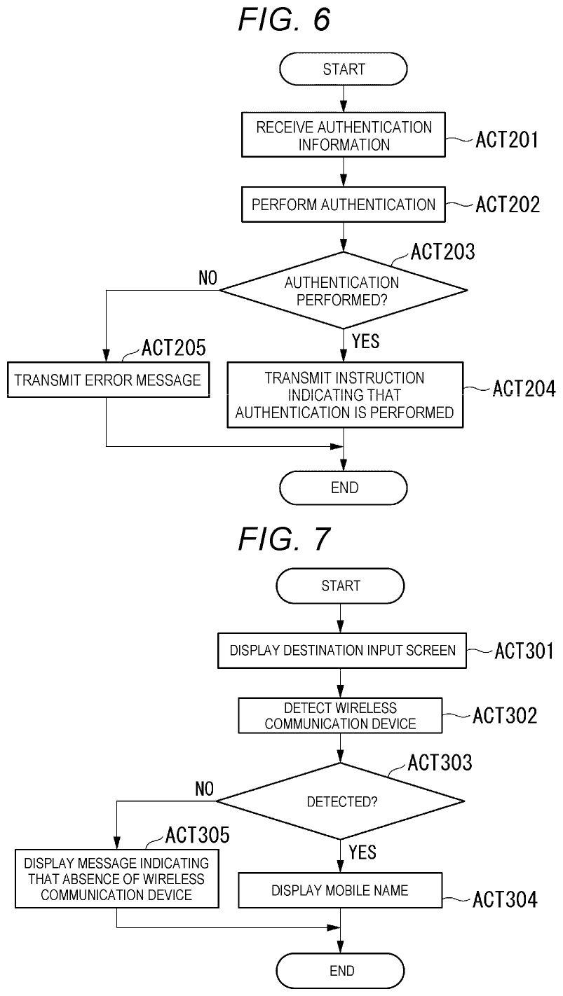

FIG. 6 is a flowchart showing a flow of an authentication process in the wireless communication device 50 of the first embodiment.

The network interface 53 receives the authentication information transmitted from the image forming device 100 (ACT 201). The network interface 53 outputs the received authentication information to the control unit 56. The control unit 56 compares the received authentication information with the authentication information registered in the address information table in the process of ACT 106 to perform authentication (ACT 202).

If the received authentication information matches the authentication information registered in the address information table in the process of ACT 106, the control unit 56 determines that the authentication is performed. If the received authentication information does not match the authentication information registered in the address information table in the process of ACT 106, the control unit 56 determines that the authentication is not performed.

The control unit 56 determines whether the authentication is performed (ACT 203). If the authentication is performed (ACT 203: YES), the control unit 56 controls the network interface 53 to transmit an instruction indicating that the authentication including the destination information selected in the process of ACT 101 and the publication level information is performed to the image forming device 100 (ACT 204).

On the other hand, when the authentication is not performed (ACT 203: NO), the control unit 56 controls the network interface 53 to transmit an error message to the image forming device 100 (ACT 205).

FIG. 7 is a flowchart showing a flow of a display process of the wireless communication device 50 in the image forming device 100 of the first embodiment.

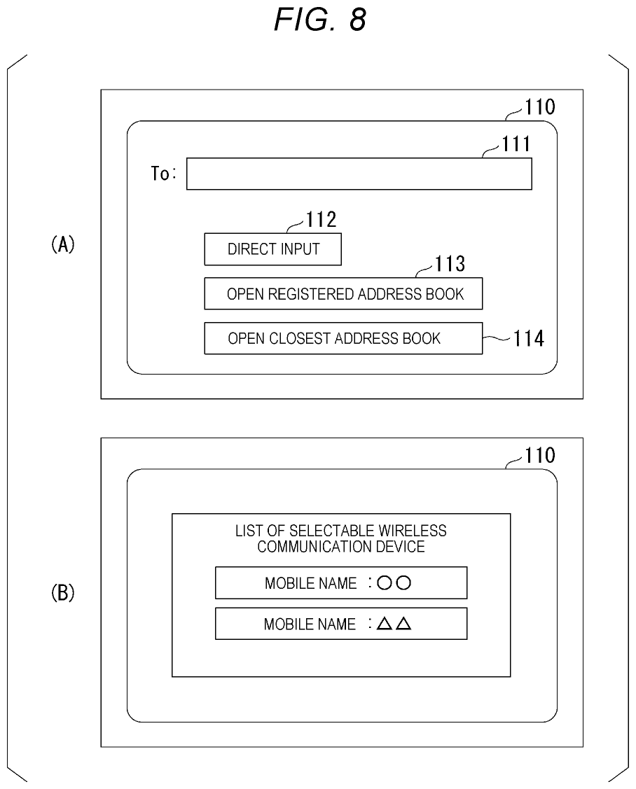

The control unit 60 of the image forming device 100 displays a destination input screen on the display 110 and receives the input of the destination according to the operation of the user (ACT 301). For example, the control unit 60 displays the destination input screen shown in (A) in FIG. 8 on the display 110 and accepts the destination input.

FIG. 8 is a diagram showing an example of a screen displayed on the display 110 of the image forming device 100. A destination input area 111 and selection buttons 112 to 114 are displayed on the destination input screen shown in (A) in FIG. 8. The destination input area 111 is an area for inputting information on the destination to be a transmission destination by the transmission function executed by the image forming device 100. The selection buttons 112 to 114 represent buttons for selecting a method for inputting information on a destination.

The selection button 112 is a button that is selected when the destination is directly input. The selection button 113 is a button selected when a destination is selected and input from a registered address book showing a list of destination information registered in the image forming device 100. The selection button 114 is a button selected when the destination information registered in the wireless communication device 50 is input as a destination.

When the selection button 114 is selected (pressed) by the user, the image forming device 100 detects the wireless communication device 50 capable of communicating with the image forming device 100 (ACT 302). Specifically, the control unit 60 controls the network interface 170 to broadcast-transmit a signal including information requesting a mobile name. The control unit 60 determines whether the wireless communication device 50 capable of communicating with the image forming device 100 is detected (ACT 303). When a response to the broadcast transmission is received, the control unit 60 determines that the wireless communication device 50 capable of communicating with the image forming device 100 is detected. When a response to the broadcast transmission is not received, the control unit 60 determines that the wireless communication device 50 capable of communicating with the image forming device 100 is not detected.

When the control unit 60 detects the wireless communication device 50 capable of communicating with the image forming device 100 (ACT 303: YES), the control unit 60 displays the mobile name given to the received response on the display 110 (ACT 304). For example, the control unit 60 causes the display 110 to display the mobile name as shown in (B) in FIG. 8. In an example shown in (B) in FIG. 8, two wireless communication devices 50 are displayed as a list of selectable wireless communication devices 50. The user may select a mobile name corresponding to a target wireless communication device 50.

On the other hand, when the control unit 60 does not detect the wireless communication device 50 capable of communicating with the image forming device 100 (ACT 303: NO), the control unit 60 displays an error message indicating that the absence of the wireless communication device 50 on the display 110 (ACT 305).

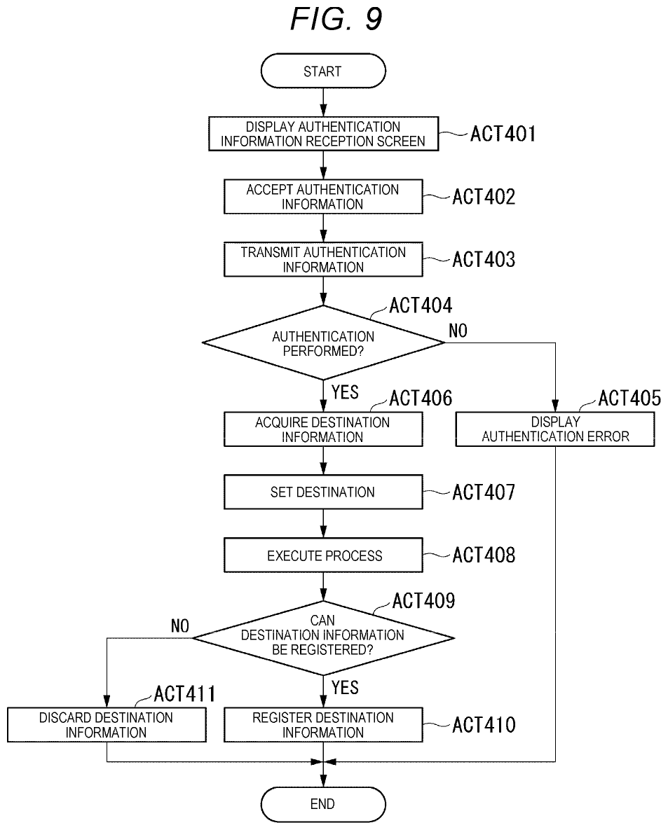

FIG. 9 is a flowchart showing a flow of a destination setting process performed by the image forming device 100 of the first embodiment. The process of FIG. 9 is executed when the user selects the mobile name corresponding to the target wireless communication device 50 in the process of FIG. 7.

The control unit 60 of the image forming device 100 switches a screen shown in (B) in FIG. 8 to an authentication information reception screen (ACT 401). The authentication information reception screen is a screen that accepts the input of the authentication information. The control unit 60 displays the authentication information reception screen on the display 110 to accept the input of the authentication information (ACT 402). The user inputs the authentication information displayed on the wireless communication device 50 in the process of FIG. 8 on the authentication information reception screen.

When the authentication information is input, the control unit 60 controls the network interface 170 to transmit the input authentication information to the wireless communication device 50. At this time, the network interface 170 broadcast-transmits a signal including the authentication information and identification information given to the response. By including the identification information, the wireless communication device 50 that has received the signal transmitted by the broadcast can determine whether the signal is addressed to its own device.

The control unit 60 determines whether the authentication based on the authentication information is performed (ACT 404). When an instruction indicating that the authentication is performed is obtained from the wireless communication device 50, the control unit 60 determines that the authentication based on the authentication information is performed. The instruction to the fact that the authentication is performed includes the destination information and the publication level information. On the other hand, when the instruction indicating that the authentication is not performed is obtained from the wireless communication device 50, the control unit 60 determines that the authentication based on the authentication information is not performed.

When the authentication based on the authentication information is not performed (ACT 404: NO), the control unit 60 displays a message indicating an authentication error on the display 110 (ACT 405). After that, the image forming device 100 ends the process of FIG. 9.

On the other hand, when the authentication based on the authentication information is performed (ACT 404: YES), the control unit 60 acquires the destination information and the publication level information that are included in the instruction indicating that the authentication is performed (ACT 406).

The control unit 60 sets the destination indicated by the acquired destination information in the destination input area 111 on the destination input screen (ACT 407). After that, the process by the transmission function is executed according to the execution instruction of the user (ACT 408). When the transmission function is scanning transmission, the image forming device 100 transmits scanned image data to the destination.

After that, the control unit 60 determines whether the destination information can be registered based on the publication level information (ACT 409). When the publication level information indicates public (unrestricted), the control unit 60 determines that the destination information can be registered. On the other hand, when the publication level information indicates public (restricted), the control unit 60 determines that the destination information cannot be registered.

When the destination information can be registered (ACT 409: YES), the control unit 60 records (registers) the destination information in the auxiliary storage device 180 (ACT 410). On the other hand, when the destination information cannot be registered (ACT 409: NO), the control unit 60 discards the destination information without registering the destination information (ACT 411).

According to the destination setting system 10 configured as described above, the destination information that is not registered in advance in the image forming device 100 and is registered in the wireless communication device 50 can be automatically set as the destination. As a result, the user does not have to manually input the destination, which can reduce time and effort. Further, it is also possible to reduce an input error caused by the user manually inputting the destination.

### Second Embodiment

In a second embodiment, a configuration in a case where an image forming device includes a function of reading code information will be described.

A system configuration in the second embodiment is the same as that in the first embodiment. Hereinafter, differences from the first embodiment will be described.

The configuration of the wireless communication device 50 in the second embodiment is the same as that in the first embodiment. In the wireless communication device 50 in the second embodiment, apart of a process performed by the control unit 56 is different from that in the first embodiment. Specifically, in addition to generation of the authentication information, the control unit 56 generates the code information including the authentication information and access information to the wireless communication device 50 (for example, a MAC address). The code information is, for example, a one-dimensional bar code or a two-dimensional code (for example, a QR code (registered trademark)).

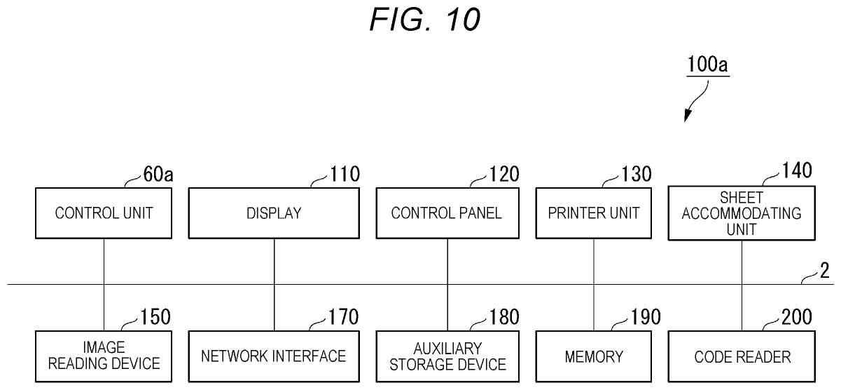

FIG. 10 is a block diagram showing a hardware configuration of an image forming device 100a according to the second embodiment.

The image forming device 100a includes a control unit 60a, the display 110, the control panel 120, the printer unit 130, the sheet accommodating unit 140, the image reading device 150, the network interface 170, the auxiliary storage device 180, the memory 190, and a code reader 200. Functional units are connected each other so as to mutually perform data communication via the system bus 2.

The image forming device 100a has a different configuration from the image forming device 100 in that the control unit 60a is provided instead of the control unit 60 and the code reader 200 is newly provided. Other configurations of the image forming device 100a are the same as those of the image forming device 100.

The code reader 200 is a reader that can read code information. The code reader 200 outputs the read code information to the control unit 60a.

The control unit 60a is a processor such as a CPU or GPU. The control unit 60a controls operations of the functional units of the image forming device 100a. The control unit 60a executes various processes by loading a program stored in a ROM or the auxiliary storage device 180 into a RAM and executing the program. The ASIC may have an appropriate function realized by the control unit 60a. The ASIC is a dedicated circuit for realizing a specific function.

Here, an example of a process of the control unit 60a will be described. The control unit 60a sets destination information received by the network interface 170 as a destination in the transmission function of the image data. When publication level information given to the destination information indicates public (unrestricted), the control unit 60a records the destination information in the auxiliary storage device 180. The control unit 60a may display screen data for selecting whether to record the destination information on the display 110, and record the destination information when an instruction for recording the destination information is input.

The control unit 60a controls the network interface 170 to transmit the authentication information to the wireless communication device 50 indicated by the access information included in the code information read by the code reader 200.

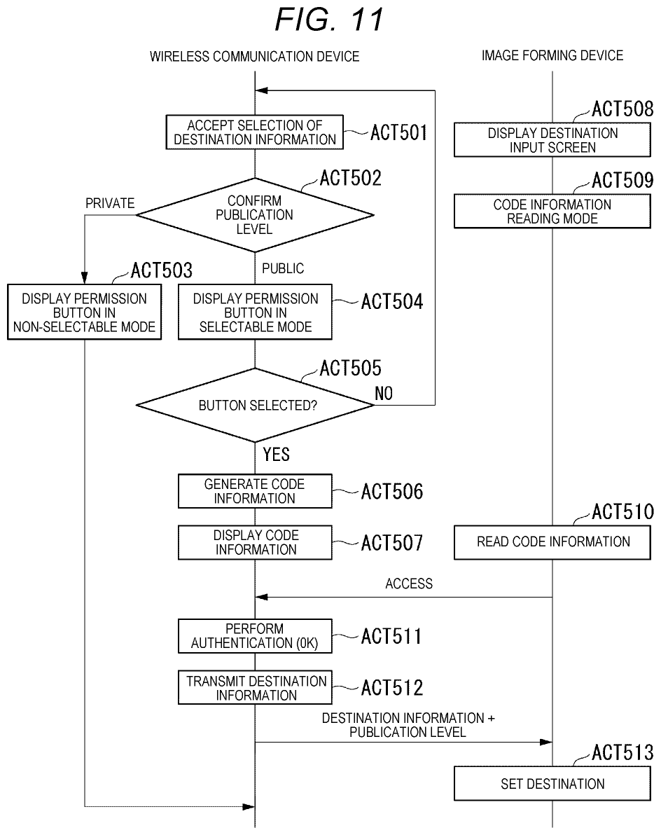

FIG. 11 is a sequence diagram showing a flow of a process of the destination setting system. 10 in the second embodiment.

The control unit 56 of the wireless communication device 50 displays a destination selection screen on the display 52 and accepts a selection of the destination information according to an operation of a user (ACT 501). When one registered destination name is selected by the user, the control unit 56 switches a screen of the wireless communication device 50 from the destination selection screen to a transmission permission screen.

When the control unit 56 switches the screen of the wireless communication device 50 from the destination selection screen to the transmission permission screen, the control unit 56 confirms a publication level associated with the selected registered destination name with reference to the address information table (ACT 502). When the publication level associated with the selected registered destination name is private (ACT 502: private), the control unit 56 displays a permission button on the transmission permission screen in a non-selectable manner (ACT 503). After that, a process of FIG. 11 ends.

On the other hand, when the publication level associated with the selected registered destination name is public (ACT 502: public), the control unit 56 displays the permission button on the transmission permission screen in a selectable manner (ACT 504). After that, the control unit 56 determines whether the permission button is selected by the user (ACT 505). When the permission button is not selected (ACT 505: NO), the process returns to ACT 501.

When the permission button is selected (ACT 505: YES), the control unit 56 generates the code information (ACT 506). Specifically, first, the control unit 56 generates the authentication information as in the first embodiment. Next, the control unit 56 generates the code information by encoding the generated authentication information and address information. The control unit 56 registers the generated authentication information in an item of authentication information associated with the selected registered destination name in the address information table. At this time, the control unit 56 also registers information on a valid period of the authentication information. After that, the control unit 56 displays the generated code information on the screen of the wireless communication device 50 (ACT 507).

The user of the wireless communication device 50 moves to the image forming device 100a and operates the image forming device 100a. The control unit 60a of the image forming device 100a displays the destination input screen on the display 110 and receives an input of a destination according to the operation of the user (ACT 508). In the image forming device 100a, the selection button 114 may not be displayed on the destination input screen. When the destination input area 111 is selected by the user instead of the selection button 112 or the selection button 113, the image forming device 100a functions as a code information reading mode (ACT 509). The code information reading mode is a mode for reading code information.

The control unit 60a of the image forming device 100a causes the display 110 to display an instruction for causing the code reader 200 to read the code information. As a result, the user brings the code information displayed on the screen of the wireless communication device 50 close to the code reader 200. The code reader 200 reads the code information displayed on the screen of the wireless communication device 50 (ACT 510). The code reader 200 outputs the read code information to the control unit 60a.

The control unit 60a acquires the access information included in the code information and the authentication information. The control unit 60a controls the network interface 170 to transmit the acquired authentication information to the wireless communication device 50 indicated by the acquired access information. The network interface 170 transmits the authentication information to the wireless communication device 50 indicated by the access information.

The network interface 53 of the wireless communication device 50 receives the authentication information transmitted from the image forming device 100a. The network interface 53 outputs the received authentication information to the control unit 56. The control unit 56 compares the received authentication information with the authentication information registered in the address information table in the process of ACT 505 to perform authentication (ACT 511).

If the received authentication information matches the authentication information registered in the address information table in the process of ACT 505, the control unit 56 determines that the authentication is performed. If the received authentication information does not match the authentication information registered in the address information table in the process of ACT 505, the control unit 56 determines that the authentication is not performed. If the authentication is not performed, the wireless communication device 50 may send an error message to the image forming device 100a. In FIG. 11, the authentication is performed.

The control unit 56 controls the network interface 53 to transmit an instruction indicating that the authentication including the destination information selected in the process of ACT 501 and the publication level information is performed to the image forming device 100a (ACT 512).

The network interface 170 of the image forming device 100a receives an instruction transmitted from the wireless communication device 50. The network interface 170 outputs the received instruction to the control unit 60a. The control unit 60a acquires the destination information included in the instruction output from the network interface 170 and the publication level information. The control unit 60a sets the destination indicated by the acquired destination information in the destination input area 111 on the destination input screen (ACT 513). After that, the control unit 60a executes the process after ACT 408 in FIG. 9.

According to the image forming device 100 in the second embodiment configured as described above, the same effect as that in the first embodiment can be obtained.

Further, in the second embodiment, it is possible to perform communication of a specific wireless communication device 50 without broadcasting transmission by acquiring the code information in the image forming device 100a. Therefore, it is not necessary for the user to select one wireless communication device 50 from wireless communication devices 50 that are candidates for authentication displayed on the image forming device 100a. As a result, it is possible to reduce an error in authentication due to a selection error of the wireless communication device 50.

(Modification in Second Embodiment)

The flow of the process in FIG. 11 is an example, and the process may not be performed in an order shown in FIG. 11. For example, the processes of the ACT 508 and the ACT 509 may be performed first in the image forming device 100a, and then the process of the ACT 501 may be performed in the wireless communication device 50.

A computer may realize at least part of certain functions of the wireless communication device 50, the image forming device 100, and the image forming device 100a in the above embodiments. In this case, a program for realizing these functions is recorded on a computer-readable recording medium. These functions may be realized by causing a computer system to read and execute the program recorded in the recording medium in which the program is recorded. The term “computer system” includes hardware such as an operating system and a peripheral device. The term “computer-readable recording medium” refers to a portable medium, a storage device, and the like. The portable medium is a flexible disk, a magneto-optical disk, a ROM, a CD-ROM, and the like. The storage device is a hard disk or the like built in the computer system.

Further, the “computer-readable recording medium” is a medium that dynamically stores a program for a short period of time, such as a communication line when a program is transmitted via a communication line. The communication line is a network such as the Internet, a telephone line, and the like. The “computer-readable recording medium” may be a volatile memory inside the computer system that serves as a server or client. The volatile memory stores a program for a certain period of time. Further, the program may be for realizing part of the functions described above. The program may further realize the above functions in combination with the program recorded in the computer system.

While certain embodiments have been described these embodiments have been presented by way of example only, and are not intended to limit the scope of the disclosure. Indeed, the novel embodiments described herein may be embodied in a variety of other forms: furthermore various omissions, substitutions and changes in the form of the embodiments described herein may be made without departing from the spirit of the disclosure. The accompanying claims and there equivalents are intended to cover such forms or modifications as would fall within the scope and spirit of the disclosure.

What is claimed is:

1. An image forming device configured to operate in a destination setting system, the destination setting system including the image forming device and a wireless communication device used by a user who uses the image forming device, the image forming device comprising:
a communication interface configured to receive destination information transmitted from the wireless communication device among one or more destination information stored in the wireless communication device; and
a controller configured to set the destination information received by the communication interface as a destination in a transmission function of image data.

2. The device according to claim 1, further comprising:
an operation interface configured to accept an input of authentication information used for authentication in the wireless communication device, wherein
the communication interface is configured to transmit the authentication information input via the operation interface to the wireless communication device, and receive the destination information transmitted from the wireless communication device when authentication based on the authentication information is performed in the wireless communication device.

3. The device according to claim 2, wherein
the controller is configured to display a mobile name of one or more wireless communication devices configured to communicate on a display when the one or more wireless communication devices configured to communicate are provided around the image forming device,
the operation interface further configured to accept a selection input of the mobile name displayed on the display, and
the communication interface configured to transmit the authentication information input via the operation interface to the wireless communication device specified by the selected mobile name.

4. The device according to claim 1, wherein
publication level information indicating whether the destination information is capable of being registered is included with the destination information, and
the controller is configured to record the destination information in an internal storage when the publication level information included with the destination information indicates that the destination information is capable of being registered.

5. The device according to claim 4, wherein
the controller is configured to cause the display to display screen data for selecting whether the destination information is recorded in the internal storage, and record the destination information in the internal storage when an instruction to record the destination information in the internal storage is input.

6. The device according to claim 1, further comprising:
a code reader configured to read code information, wherein
the code information includes the authentication information used for the authentication in the wireless communication device and access information to the wireless communication device, and
the communication interface is configured to transmit the authentication information to the wireless communication device indicated by the access information included in the code information read by the code reader, and receive the destination information transmitted from the wireless communication device when the authentication based on the authentication information is performed in the wireless communication device.

7. The device according to claim 1, wherein
the transmission function of the image data is a function for performing at least one of fax transmission or scanning transmission, and
the controller is configured to set a destination indicated by the destination information received by the communication interface as a destination at a time of using any one of the fax transmission or the scanning transmission.

8. The device according to claim 2, wherein
the authentication information is a one-time password.

9. A destination setting method for an image forming system, the image forming system including an image forming device and a wireless communication device used by a user who uses the image forming device, the destination setting method comprising:
transmitting, by the wireless communication device, destination information designated by the user among one or more destination information stored in the wireless communication device to the image forming device;
receiving, by the image forming device, the destination information transmitted from the wireless communication device; and
setting, by the image forming device, the received destination information as a destination in a transmission function of image data.

10. A non-transitory recording medium for recording a computer program that causes a computer as an image forming device configured to operate in a destination setting system to execute information processing, the destination setting system including the image forming device and a wireless communication device used by a user who uses the image forming device, the information processing comprising:
receiving destination information transmitted from the wireless communication device among one or more destination information stored in the wireless communication device, and
setting the received destination information as a destination in a transmission function of image data.

11. The device according to claim 1, wherein the destination information includes at least one of a telephone number or an e-mail address.

12. The device according to claim 1, wherein the wireless communication device includes at least one of a personal computer, a notebook computer, a tablet terminal, or a smartphone.

13. The device according to claim 1, wherein the image forming device includes a multi function peripheral.

14. The device according to claim 1, wherein the destination information is stored in a table of the wireless communication device.

15. The device according to claim 1, wherein the controller includes at least one processor.

16. The device according to claim 1, wherein the communication interface is configured to transmit an error message when authentication is not performed.

17. The device according to claim 4, wherein the publication level information includes an indication of whether the destination information is public or private information.

18. The device according to claim 17, wherein the public information is restricted.

19. The method according to claim 9, further comprising:
accepting an input of authentication information used for authentication in the wireless communication device; and
transmitting the authentication information to the wireless communication device, and receiving the destination information transmitted from the wireless communication device when authentication based on the authentication information is performed in the wireless communication device.
